(19) United States
(12) Patent Application Publication
(10) Pub. No.: US 2010/0194590 A1
(43) Pub. Date: Aug. 5, 2010

(54) HEATING SYSTEM

(75) Inventor: Nicholas David Beckett, Muckamore (GB)

Correspondence Address: WITHROW & TERRANOVA, P.L.L.C., 100 REGENCY FOREST DRIVE, SUITE 160, CARY, NC, 27518, US

(73) Assignee: HOTHOUSE TECHNOLOGIES LIMITED, Holywood (GB)

(21) Appl. No.: 12/601,463

(22) PCT Filed: May 20, 2008
(86) PCT No.: PCT/EP2008/004037

§ 371 Date: Nov. 23, 2009

(30) Foreign Application Priority Data
May 25, 2007 (GB) 0710087.8

(51) Int. Cl. G08C 19/00

(52) U.S. Cl. 340/870.3

(57) ABSTRACT

A heating system comprising at least one temperature sensing device in the form of a wireless transponder. Preferably the temperature sensing device comprises an RFID transponder which may take the form of a substantially planar patch. Preferably said at least one temperature sensing device is arranged for communication with at least one communications relay node via a wireless link. In use, the or each temperature sensing device may send to the or each relay node information indicating the temperature measured by the sensor and, preferably, an identifier that uniquely identifies the respective temperature sensor.

This application is a 35 USC 371 National Phase Application of International application number PCT/EP2008/004037 filed May 20, 2008, which claims priority to United Kingdom patent application 0710087.8 filed May 25, 2007, the disclosures of which are incorporated herein by reference in their entireties.

### FIELD OF THE INVENTION

The present invention relates to heating systems and in particular to multi-zone heating systems

### BACKGROUND TO THE INVENTION

Recent government building legislation supports the understanding that heating systems need to be increasingly responsive and efficient to meet current and future needs and expectations.

A standard domestic system typically has one closed loop component controlling the energy supplied into the living spaces. A binary state (on/off) thermostat is fixed in one location within the premises, typically the hall or the lounge. When the set temperature is reached the thermostat causes the heating be turned off. A typical electro-mechanical thermostatic device has an inherent control hysteresis whereby a drop in room temperature exceeding the hysteresis value (typically 0.5° C.) brings the heating system back on, providing that an overriding timing controller is enabled.

In recent years the TRV (Thermal Regulating Valve) has been deployed throughout radiator based systems in order to improve the system performance and efficiency by enabling a degree of local control feedback in rooms without the benefit of the control offered by the thermostat itself.

Furthermore, recent legislation proposes the provision of additional thermostatically controlled zones in proportion to the floor area of the property to be heated.

The advent of under floor heating systems has increased the use of multiple zoned thermostatic control. Typically each individually piped circuit is fed from a manifold distribution system and the flow is provided by a fixed speed motor or pump which is in turn connected to the binary state thermostat. As with the radiator based system, the control mechanics simply enable or disable a fixed energy input to the respective controlled circuit.

All binary state thermostat controls have a significant hysteresis by necessity and the resulting temperature control is an oscillation about the target temperature. It is typical for the magnitude of the oscillation to exceed 2° C. taking into account the device hysteresis and the predictable thermal dynamics and delays resulting in undershoot and overshoot effects following any switching event.

Digital electronic technology can provide an improved form of thermal feedback control by communicating a measured value enabling and error or offset value to be derived instead of simply turning the heating system on or off. If the system allows it is therefore possible to improve the thermal control by modulation of the energy input using gas boiler modulation or the flow temperature using a motorised mixing valve. This type of quantified feedback can typically reduce thermal oscillations to within about ±0.25° C.

Application of the improved digital control methodology to multiple zones is technically feasible but complex and costly using conventional techniques. A number of possibilities can be envisaged comprising multiple motorised valves with related thermal measurement devices. To enable the necessary communication every measurement device would require physical connection to a power source and/or communications wiring. If a wireless approach is considered the power requirements for transceivers or transponders become a concern, especially with regard to the containment and replacement of batteries.

It would be desirable to mitigate the problems outlined above.

### SUMMARY OF THE INVENTION

Accordingly, a first aspect of the invention provides a heating system comprising at least one temperature sensing device in the form of a wireless transponder, preferably an RFID transponder. In the preferred embodiment, said at least one temperature sensor takes the form of a substantially planar patch.

Preferably, said at least one temperature sensing device is arranged for communication with at least one communications relay node, preferably via a wireless link. In use, the or each temperature sensing device sends to the or each relay node information indicating the temperature measured by the sensor and, preferably, an identifier that uniquely identifies the respective temperature sensor.

Said at least one communications relay node is advantageously arranged for communication with a controller, preferably via a wireless link, or optionally via a wired link.

In preferred embodiments, said at least one relay node is incorporated into a socket assembly, the socket assembly conveniently being mounted on or in a wall, floor or ceiling surface of a room or building structure. Advantageously, the socket assembly is connectable to an electrical power supply, especially a mains power supply. Conveniently, the socket assembly comprises an electrical plug socket, and/or and aerial socket and/or a computer terminal. Typically, the socket assembly includes a fascia plate, the relay node being integrated within or carried by the reverse face of the fascia plate.

In the preferred embodiment, the controller is arranged to control the operation of one or more control devices depending on the information received from the node(s), wherein the or each control device controls the operation of one or more heat radiating devices. Preferably, the or each control device comprises or includes a proportional control valve, or similar device, for example a pump or other device with flow control ability, e.g. a variable speed pump.

The preferred heating system includes a plurality of heating circuits, each circuit comprising at least one radiating device and being associated with at least one of said control devices and with at least one of said temperature sensing devices, wherein the controller controls said at least one control device depending on a comparison between the temperature measured by said temperature sensing device(s) and a target temperature. This allows a multi-zone heating system to be implemented in which the temperature in each zone can be controlled separately and effectively.

A second aspect of the invention provides a communications relay node, especially but not exclusively for use in a heating system, the node being incorporated into a socket assembly, the socket assembly conveniently being mounted on or in a wall, floor or ceiling surface of a room or building structure.

A third aspect of the invention provides a heating system includes a plurality of heating circuits, each circuit comprising at least one radiating device and being associated with at least one control devices and with at least one temperature sensing device, wherein the controller controls said at least one control device depending on a comparison between the temperature measured by said temperature sensing device(s) and a target temperature

Further advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is a schematic view of a heating system embodying a first aspect of the invention; and

FIG. 2 is a schematic view of part of a heating system suitable for use in the heating system of FIG. 1.

### DETAILED DESCRIPTION

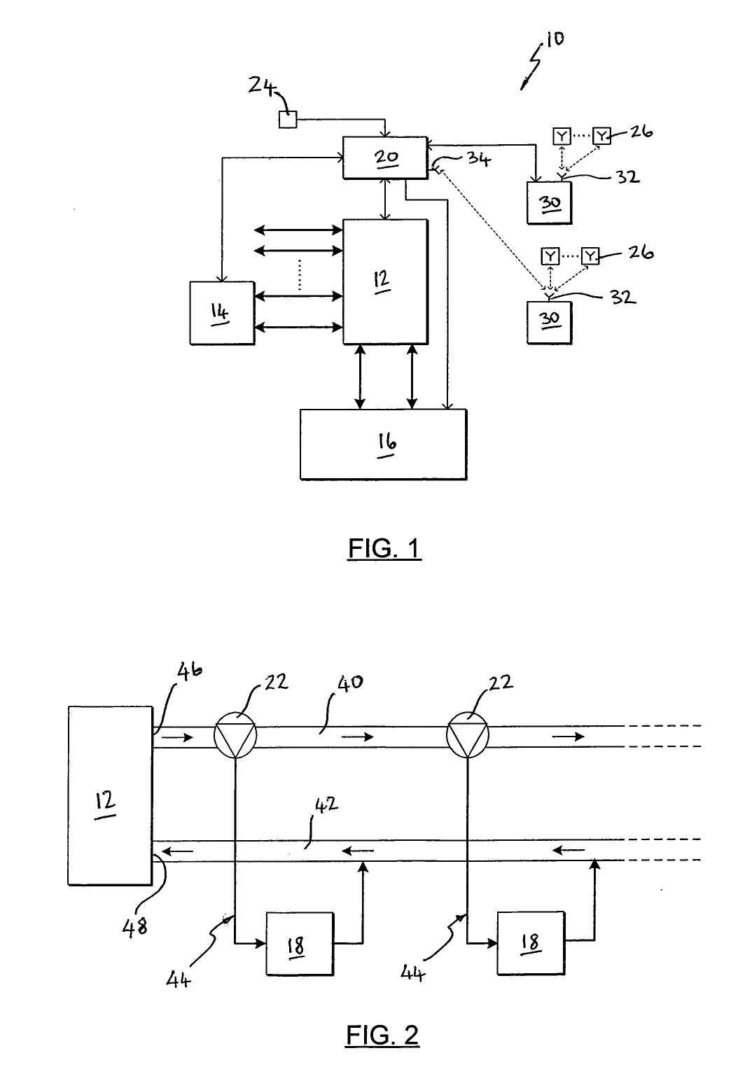

Referring now to FIG. 1 of the drawings, there is shown, generally indicated as 10, a heating system embodying a first aspect of the invention. The system 10 comprises a reservoir 12 for storing a fluid heating medium, typically water or other liquid. The reservoir 12 may comprise one or more tanks or other storage means. One or more heating devices, or energy sources, are coupled to the reservoir 12 in order to heat the medium. Typically, the heating devices include a boiler 14, for example a conventional oil burning or gas burning boiler. Additional boilers and/or one or more renewable energy sources (not shown), e.g. a solar energy system, may also be coupled to the reservoir 12.

The reservoir 12 is coupled to a thermal load 16 comprising one or more heat radiating devices 18 (FIG. 2), e.g. radiators or under floor heating elements. The thermal load 16 typically comprises one or more heating circuits, each circuit feeding one or more radiating device 18.

A control unit 20 is provided for controlling the operation of system 10, in particular the operation of the energy sources and of any pumps, valves, motors or other controllable devices included in or associated with the system 10. In the illustrated embodiment, it will be seen that the controller 20 is in communication with the boiler 14 in order to enable exchange of parametric data between the two devices and deliver an integrated control behaviour. The controller 20 is also in communication with the thermal load 16 or, more particularly, to any controllable devices (e.g. pumps 22 shown in FIG. 2) associated with the thermal load 16, for controlling the operation of its radiating devices 18. The controller 20 may also be in communication with a thermostat 24 in conventional manner. Communication between the controller 20 and the various other components of the system 10 may be implemented by any conventional means suitable for conveying the necessary signals, typically a hardwired connection, although wireless communication could be employed. The controller 20 typically comprises a suitably programmed microprocessor, microcontroller or other programmable processor or controller.

The flow of the heating medium around the system 10 may be effected by any suitable conventional means, typically pipes or other fluid conduits which are indicated schematically by arrows in FIGS. 1 and 2 unless otherwise stated.

The system 10 is particularly intended for use as a multi-zone heating system in which the heating in different zones can be controlled independently in accordance with the requirements of the zone. A zone may for example comprise a single room, a set of rooms, one or more floors of a multi-floor building, or any other defined region within the building(s) services by the system 10. To this end, the system 10 further includes at least one, but typically a plurality of, temperature sensing devices 26. For example, a respective temperature sensing device 26 may provided for each zone.

In the preferred embodiment, each temperature sensing device 26 comprises a transponder capable of, in response to receiving an interrogation signal, transmitting a signal carrying information that indicates the measured temperature. In addition, it is preferred that the transmitted signal includes an identifier that is unique to the device 26. Advantageously, the sensing device 26 is capable of sending and receiving such signals by means of a wireless communications link. To this end, the device 26 comprises a wireless transceiver (not shown), typically comprising an integrated circuit, coupled to an antenna. The device 26 also includes means for storing its unique identifier and a processor (not shown), typically in the form of an integrated circuit, for controlling the operation of the device 26, which may or may not be integrated with the transceiver.

It is particularly preferred that the temperature sensing device 26 is substantially planar in form and may for example take the form of a patch. This allows the device 26 to be incorporated unobtrusively into a building. For example, the device 26 may be fixed to an internal wall and painted or papered over. In such cases, the antenna conveniently comprises a planar antenna, for example a flat coil antenna. Packaged thermal sensor devices exist (e.g. Microchip TC77) as fully integrated silicon devices designed to communicate with a host processor using a serial protocol. Such devices can be seamlessly integrated either in silicon die format or preferably onto a common silicon substrate peripheral to the host processor circuit.

In some cases, it may be possible for the temperature sensing devices 26 to communicate directly with the controller 20 in order to relay temperature information and identification information thereto. Typically, however, and especially where low powered wireless communication is used, it is preferred that the system 10 further includes one or more communication relay nodes 30. Each relay node 30 includes means for transmitting and receiving signals between the node 30 and the controller 20, and between the node 20 and at least one temperature sensing device 26.

In the preferred embodiment, the nodes 30 are equipped to communicate wirelessly with the, or each associated temperature sensor 26. To this end, each node 30 has transceiver circuitry (not shown) coupled to an antenna 32. The node 30 also includes a processor (not shown), typically in the form of an integrated circuit, for controlling the operation of the node 30, which may or may not be integrated with the transceiver.

In use, the node 30 communicates with the, or each, temperature sensor 26 associated with it in order to determine the temperature measured by the sensor 26. The unique identifier provided by the sensor 26 allows the node 30 to establish from which sensor 26 a given measurement has emanated.

In the preferred embodiment, the node 30 and sensor 26 are arranged to operate as an RFID (Radio Frequency Identification Device) in which the sensor 26 comprises an RFID tag or transponder. Upon receipt of an interrogation signal from the node 30, the sensor 26 transmits its measured temperature and unique identifier to the node 30. A particular advantage of this embodiment is that the sensor 26 does not require an internal power source since its power is derived from the received interrogation signal.

Alternatively, the sensor 26 may be configured to transmit its data periodically or even continuously to the node in which case the sensor does not require a receiver. However, this would require the sensor 26 to have an internal power source, or a connection to an external power source, both of which are considered to be undesirable. Alternatively still, the sensors 26 may communicate with the nodes and/or the controller 20 by a wired link, although this is undesirable in terms of the disruption to the building.

Communication between the nodes 30 and the controller 20 is preferably via a wireless link, typically using a different frequency and aerial than are used for communication with the sensor(s) 26. If deemed feasible the nodes 30 may use the transceiver/antenna circuitry provided for communication with the sensors 26. The controller 20 may therefore also be equipped with transceiver circuitry (not shown) coupled to an antenna 34. Typically, the arrangement is such that the wireless link between the nodes 30 and the controller 20 is a medium range link optimized for operation within a building structure. This is in contrast to an RFID wireless link which is typically short range. Alternatively, the nodes 30 and the controller 20 may communicate via wired links. Each node 30 may include or may be connectable to an electrical power source such as a battery, or may be connectable to a mains electricity supply.

In a preferred embodiment, each node 30 is incorporated into a socket assembly such as those commonly provided in the walls, floor or ceiling of a room, e.g. a plug socket, aerial socket or computer network socket (not shown). Such socket assemblies typically comprise a fascia plate which, in use, is located on or in the wall, floor or ceiling surface of a room, and is commonly formed from plastics. Various electrical and/or mechanical components are provided behind the fascia plate depending on the type of socket. Usually, the sockets provide access to an electrical power supply, typically the mains supply, e.g. are connected to the power supply or at least provide, or can readily be adapted to provide, a connection to the power supply. Most conveniently, the node 30 is mounted to the reverse face of the fascia plate.

By incorporating one or more nodes 30 into a socket, a number of advantages are obtained. Firstly, the node 30 is unobtrusive since it is incorporated into a socket which is already present in the room. Secondly, the node 30 is able to be connected to and powered by the electrical power supply, typically the mains supply, available at the socket. Thirdly, in the event that a wired communication link is preferred between the node 30 and the controller 20, this may be provided as a mains-borne communication link, i.e. via the wiring provided for the electricity supply.

In use, each node 30 communicates with the, or each, sensor 26 with which it is associated, and in the preferred embodiment proximally located, to gather information concerning the measured temperature at each sensor 26. The nodes 30 then relay this information to the controller 20. This information allows the controller 20 to control the operation of the heating system 10 in response to the measured temperatures. In particular, it will be apparent that the relayed information allows the system 20 to operate as a multi-zone heating system, wherein at least one temperature sensor 26 is associated with each zone. In one embodiment, at least one temperature sensor 26 is associated with each radiating device 18 and this allows the controller 20 to individually control the operation of each radiating device 18 in accordance with the temperature measured by the, or each, associated sensor 26. In such an embodiment, there may be a one-to-one correspondence between zones and radiating devices 18, i.e. one radiating device per zone and vice versa, or each zone may be associated with more than one radiating device.

The ability of the controller 20 to control the operation of the system 10 is dependent on the controllable components, e.g. valves, motors, pumps etc., under its command. In preferred embodiments, the system 10 includes respective means for controlling the operation of each zone. The control means preferably comprises a variable speed pump or proportional control valve.

Referring now to FIG. 2 in particular, there is shown a preferred configuration of the thermal load 16 suitable for use with the system 10. A flow conduit and a return conduit, in the preferred form of a flow manifold 40 and a return manifold 42, are connected to the reservoir 12 for directing the heating medium from and to the reservoir 12. In FIG. 2, only one main flow/return circuit/manifold is shown, although it will be understood that more than one may be provided. As such multiple manifolds may be connected to the store 12, either close coupled or integrated with the store and or remotely connected by suitable sized flow and return pipes with electrical/electronic connection as required.

At least one, but typically a plurality of, circuits 44 are connected to the manifolds 40, 42, each circuit 44 comprising at least one respective radiating device 18. Each circuit 44 provides a fluid flow path from the flow outlet 46 of the reservoir 12 to the return inlet 48 of the reservoir 12. Each circuit 44 includes, or is associated with, means for controlling the flow of heating fluid to the respective radiating device(s) 18. In the illustrated embodiment, the control means takes the form of a respective pump 22 for each circuit 44. Each pump 22 may for example be located at the take off point from the flow manifold 40 for the respective circuit 44. Advantageously, each pump 22 is operable to control the flow level of the heating fluid supplied to the respective radiating device(s) 18. To this end, the pump 22 may include a proportional control valve, or other proportional control means. In an alternative embodiment (not illustrated), the pumps may be replaced by a respective proportional control valve, or other proportional control means, in which case a single pump may be provided in the main flow/return circuit for driving the heating medium.

The pumps 22, or other control means, are individually controllable by the controller 22 in response to the temperature information received from one or more associated sensor 26. In the preferred embodiment, each circuit 44 corresponds with a respective heating zone and so the pumps 22, or other control means, allow the controller 22 to individually control each zone.

Moreover, in the preferred embodiment, the system 10 is able to operate a respective closed loop feedback system in respect of each circuit 44, and therefore each zone, in which a target temperature may be set for each zone in any convenient manner (e.g. set manually by a user and/or set automatically by the controller 20 depending for example on other system settings or measurements such as a thermostat setting or measured environmental conditions), an actual temperature value is measured by the respective sensor(s) 26 and the pump 22, or other control means, is controlled in accordance with the error signal between the two. This allows relatively accurate, damped control of the zone temperatures and so leads to a more efficient use of the heating system 10.

The invention is not limited to the embodiments described herein which may be modified or varied without departing from the scope of the invention.

1. A heating system comprising at least one temperature sensing device in the form of a wireless transponder.

2. A heating system as claimed in claim 1, wherein the temperature sensing device comprises an RFID transponder.

3. A heating system as claimed in claim 2, wherein said at least one temperature sensor takes the form of a substantially planar patch.

4. A heating system as claimed in claim 1, wherein said at least one temperature sensing device is arranged for communication with at least one communications relay node via a wireless link.

5. A heating system as claimed in claim 4, wherein, in use, the or each temperature sensing device sends to the or each relay node information indicating the temperature measured by the sensor and, preferably, an identifier that uniquely identifies the respective temperature sensor.

6. A heating system as claimed in claim 5, wherein said at least one communications relay node is arranged for communication with a controller.

7. A heating system as claimed in claim 4, wherein said at least one relay node is incorporated into a socket assembly, the socket assembly conveniently being mounted on or in a wall, floor or ceiling surface of a room or building structure.

8. A heating system as claimed in claim 7, wherein the socket assembly is connectable to an electrical power supply, especially a mains power supply.

9. A heating system as claimed in claim 8, wherein the socket assembly comprises an electrical plug socket, and/or and aerial socket and/or a computer terminal.

10. A heating system as claimed in claim 7, wherein the socket assembly includes a fascia plate, the relay node being integrated within or carried by the reverse face of the fascia plate.

11. A heating system as claimed in claim 6, wherein the controller is arranged to control the operation of one or more control devices depending on the information received from the node(s), wherein the or each control device controls the operation of one or more heat radiating devices.

12. A heating system as claimed in claim 11, wherein the or each control device comprises or includes a flow control device, such as a proportional control valve, or similar device, a pump or other device with flow control ability, such as a variable speed pump.

13. A heating system as claimed in claim 11, further comprising a plurality of heating circuits, each circuit comprising at least one radiating device and being associated with at least one of said control devices and with at least one of said temperature sensing devices, wherein the controller controls said at least one control device depending on a comparison between the temperature measured by said temperature sensing device(s) and a target temperature.

14. A communications relay node for use in a heating system, the node being incorporated into a socket assembly, the socket assembly being mountable on or in a wall, floor or ceiling surface of a room or building structure.

15. A heating system comprising a plurality of heating circuits, each circuit comprising at least one radiating device and being associated with at least one control device and with at least one temperature sensing device, wherein the controller controls said at least one control device depending on a comparison between the temperature measured by said temperature sensing device(s) and a target temperature.
